(19) United States
(12) Patent Application Publication
(10) Pub. No.: US 2026/0288154 A1
(43) Pub. Date: Sep. 24, 2026

(54) Propulsion System Performance and Life Management

(71) Applicant: General Electric Company, Evendale, OH (US)

(72) Inventors: Brian Francis Nestico, Loveland, OH (US); Zachary Noeth, Loveland, OH (US); Hejie Li, Mason, OH (US)

(21) Appl. No.: 19/085,440

(22) Filed: Mar. 20, 2025

(51) Int. Cl. G05D 1/644; G05D 1/48

(52) U.S. Cl. CPC G05D 1/644; G05D 1/48

(57) ABSTRACT

A control circuit facilitates the management of mission performance with respect to propulsion system life management (for example, for an on-wing jet turbine engine on an aircraft). The control circuit can access information regarding variable operating costs and current mission constraints for the aircraft, information regarding operator objectives, and operating parameters for the mission to provide corresponding accessed information. The control circuit can then optimize mission performance and propulsion system life management as a function of mission performance information output by an aircraft model that inputs the aforementioned accessed information, along with maintenance cost information output by at least one aircraft maintenance cost model that also inputs information corresponding to at least some of the aforementioned accessed information, to thereby output an optimized climb profile. The control circuit then operates the propulsion system in accordance with the aforementioned optimized climb profile.

### TECHNICAL FIELD

These teachings relate generally to jet engines and more particularly to the operational management thereof.

### BACKGROUND

A jet turbine engine is a type of reaction engine that discharges a fast-moving jet of fluid to generate thrust. This engine typically works by drawing air into the front with a fan, compressing the air, mixing the compressed air with fuel and igniting the mixture, which then expands rapidly and is expelled at high speed out of a nozzle at the back, propelling the aircraft forward. The core of the engine is the gas turbine, which typically includes a compressor, a combustion chamber, and a turbine that captures energy from the exhaust gases to keep the compressor running.

### BRIEF DESCRIPTION OF DRAWINGS

Various needs are at least partially met through provision of the propulsion system performance and life management apparatus and method described in the following detailed description, particularly when studied in conjunction with the drawings. A full and enabling disclosure of the aspects of the present description, including the best mode thereof, directed to one of ordinary skill in the art, is set forth in the specification, which refers to the appended figures, in which:

FIG. 1 comprises a block diagram as configured in accordance with various embodiments of these teachings;

FIG. 2 comprises a flow diagram as configured in accordance with various embodiments of these teachings;

FIG. 3 comprises a block diagram as configured in accordance with various embodiments of these teachings; and

FIG. 4 comprises a block diagram as configured in accordance with various embodiments of these teachings.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present teachings. Also, common but well-understood elements that are useful or necessary in a commercially feasible embodiment are often not depicted in order to facilitate a less obstructed view of these various embodiments of the present teachings. Certain actions and/or steps may be described or depicted in a particular order of occurrence while those skilled in the art will understand that such specificity with respect to sequence is not actually required.

### DETAILED DESCRIPTION

In a jet turbine engine, the bypass ratio is a parameter that influences engine performance, efficiency, and noise. The bypass ratio is typically defined as a ratio of a mass flow rate of air that bypasses the core of the engine to the mass flow rate of air that passes through the core. Increased engine bypass ratios and evolutions in aircraft wing design are driving higher engine flow path temperatures in the climb phase of flight that can result in a significant reduction in engine hot section hardware life. Reducing climb thrust (derate) is one approach to decreasing hardware severity and can increase engine time-on-wing. That approach, however, can degrade performance regarding such things as climb-to time, optimal cruise insertion altitude, distance-to time, block fuel, and block time. Determining, communicating, and effecting a suitably balanced approach in these regards are all significant challenges in the context of aviation application settings.

Generally speaking, the various aspects of the present disclosure can be employed with a control circuit that facilitates the management of mission performance with respect to propulsion system life management for an aircraft propulsion system (such as, for example, an on-wing jet turbine engine on an aircraft). (As used herein, “mission” refers to a plan to be carried by, for example, an aircraft. A mission might therefore comprise, for example, flying an aircraft from a first geographic location to a second, different geographic location.) By one approach, such a control circuit accesses information regarding variable operating costs for an aircraft, current mission constraints for the aircraft, information regarding operator objectives, and operating parameters for the mission to thereby provide corresponding accessed information. The control circuit then optimizes mission performance and propulsion system life management as a function, at least in part, of mission performance information output by at least one aircraft model that inputs information corresponding to at least some of the aforementioned accessed information, along with maintenance cost information output by at least one aircraft maintenance cost model that inputs information corresponding to at least some of the aforementioned accessed information, to thereby output an optimized climb profile. The control circuit then operates the corresponding on-wing jet turbine engine in accordance with the aforementioned optimized climb profile.By one approach, these teachings will accommodate having the control circuit access information regarding flight-to-flight variability to provide the aforementioned accessed information.

By one approach, the aforementioned information regarding the variable operating costs for the aircraft can comprise cost information regarding crew, fuel, and maintenance for the aircraft. By one approach, the aforementioned information regarding the current mission regarding constraints for the aircraft can comprise information regarding block time, time and distance to climb, and cruise insertion altitude. And by one approach, the aforementioned information regarding the operator objectives can comprise information regarding at least one of priorities regarding fuel versus time-based direct costs, priorities regarding near-term maintenance versus deferred maintenance, fleet maintenance planning, and minimization of unplanned engine removals.

By one approach, these teachings will accommodate configuring the control circuit as an engine model that inputs information corresponding to at least some of the aforementioned accessed information and that outputs thrust information and fuel flow information to the aforementioned at least one aircraft model.

By one approach, the aforementioned maintenance cost information output by the at least one aircraft maintenance cost model can comprise one or more of maintenance monetary cost information (representing the actual monetary cost of the corresponding maintenance activity), maintenance time cost information (representing the time required to undertake and complete the maintenance activity, maintenance headcount cost information (representing the number of persons that are required to undertake and complete the maintenance activity), maintenance facility cost information (representing the use of a particular facility to support the maintenance activity), maintenance tool cost information (representing the use of particular tools that are needed to undertake and maintain the maintenance activity), and so forth.

An optimized climb profile refers to a most efficient way for an aircraft to gain altitude from takeoff to reaching its cruising level. By one approach, the aforementioned optimized climb profile can comprise a cruise insertion altitude, climb airspeed, and at least one variable climb thrust/power demand. In lieu of the foregoing or in combination therewith, the aforementioned outputting of the optimized climb profile can further comprise outputting information regarding at least one of estimated mission operating costs and estimated mission performance.

These teachings are highly flexible in practice and will accommodate various modifications and/or supplemental features. As but one illustrative example in these regards, these teachings will accommodate having the aforementioned control circuit present on a display in a cockpit of the aircraft and/or in an offline aircraft maintenance or flight report information regarding benefits corresponding to the aforementioned optimized climb profile.

So configured, these teachings will support determining optimal mission vehicle utilization by managing vehicle performance and propulsion system hardware life consumption based on, for example, the operator's cost objectives. These teachings can allow, for example, the flight vehicle operator to prioritize direct operating costs (such as, for example, fuel, crew, and maintenance costs) on a mission-by-mission basis. These teachings will further support, for example, an optimization of mission performance and propulsion system life management based on the integration of propulsion system hardware life consumption modeling and operating cost functions into flight management planning and propulsion system power management.

The terms and expressions used herein have the ordinary technical meaning as is accorded to such terms and expressions by persons skilled in the technical field as set forth above except where different specific meanings have otherwise been set forth herein. The word “or” when used herein shall be interpreted as having a disjunctive construction rather than a conjunctive construction unless otherwise specifically indicated. The terms “coupled,” “fixed,” “attached to,” and the like refer to both direct coupling, fixing, or attaching, as well as indirect coupling, fixing, or attaching through one or more intermediate components or features, unless otherwise specified herein.

The singular forms “a”, “an”, and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms such as “about”, “approximately”, and “substantially”, are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin.

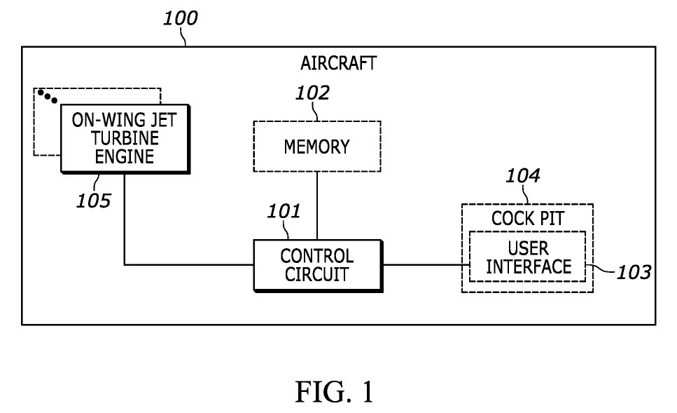

The foregoing and other benefits may become clearer upon making a thorough review and study of the following detailed description. Referring now to the drawings, and in particular to FIG. 1, an illustrative apparatus that is compatible with many of these teachings will be presented.

For the sake of an illustrative example, the following description will presume an application setting that includes an aircraft 100. This aircraft includes a control circuit 101. Being a “circuit,” the control circuit 101 therefore comprises structure that includes at least one (and typically many) electrically-conductive paths (such as paths comprised of a conductive metal such as copper or silver) that convey electricity in an ordered manner, which path(s) will also typically include corresponding electrical components (both passive (such as resistors and capacitors) and active (such as any of a variety of semiconductor-based devices) as appropriate) to permit the circuit to effect the control aspect of these teachings.

Such a control circuit 101 can comprise a fixed-purpose hard-wired hardware platform (including but not limited to an application-specific integrated circuit (ASIC) (which is an integrated circuit that is customized by design for a particular use, rather than intended for general-purpose use), a field-programmable gate array (FPGA), and the like) or can comprise a partially or wholly-programmable hardware platform (including but not limited to microcontrollers, microprocessors, and the like). These architectural options for such structures are well known and understood in the art and require no further description here. This control circuit 101 is configured (for example, by using corresponding programming as will be well understood by those skilled in the art) to carry out one or more of the steps, actions, and/or functions described herein.

It will be understood that a reference to a “control circuit” in the singular may reference a literal single discrete such device or may reference a plurality of discrete control circuits that can be viewed in the aggregate as a “control circuit.” Accordingly, references to a “control circuit” will be understood to alternatively include either a single such device or a plurality of such devices in the absence of any language to the contrary.

By one optional approach, the control circuit 101 operably couples to a memory 102. This memory 102 may be integral to the control circuit 101 or can be physically discrete (in whole or in part) from the control circuit 101 as desired. This memory 102 can also be local with respect to the control circuit 101 (where, for example, both share a common circuit board, chassis, power supply, and/or housing) or can be partially or wholly remote with respect to the control circuit 101 (where, for example, the memory 102 is physically located in another facility, metropolitan area, or even country as compared to the control circuit 101). It will also be understood that this memory 102 may comprise a plurality of physically discrete memories that, in the aggregate, store the pertinent information that corresponds to these teachings.

In addition to various items of information as described herein, this memory 102 can serve, for example, to non-transitorily store the computer instructions that, when executed by the control circuit 101, cause the control circuit 101 to behave as described herein. (As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM) as well as volatile memory (such as a dynamic random access memory (DRAM).)

By another optional approach (in lieu of the foregoing or in combination therewith), the control circuit 101 operably couples to a user interface 103. This user interface 103 can comprise any of a variety of user-input mechanisms (such as, but not limited to, keyboards and keypads, cursor-control devices, touch-sensitive displays, speech-recognition interfaces, gesture-recognition interfaces, and so forth) and/or user-output mechanisms (such as, but not limited to, visual displays, audio transducers, printers, and so forth) to facilitate receiving information and/or instructions from a user and/or providing information to a user. In this illustrative example, the user interface 103 may be located in a cockpit 104 of the aircraft 100 and/or in a location off-board the aircraft 100. These teachings will also accommodate the user interface being an offline interface such as a post-flight downloadable report that includes information regarding, for example, benefits that correspond to an optimized climb profile as described herein.

In the present example, the aircraft 100 includes at least one on-wing jet turbine engine 105. At least some operating characteristics of the on-wing jet turbine engine 105 can be controlled, at least in part, by the control circuit 101.

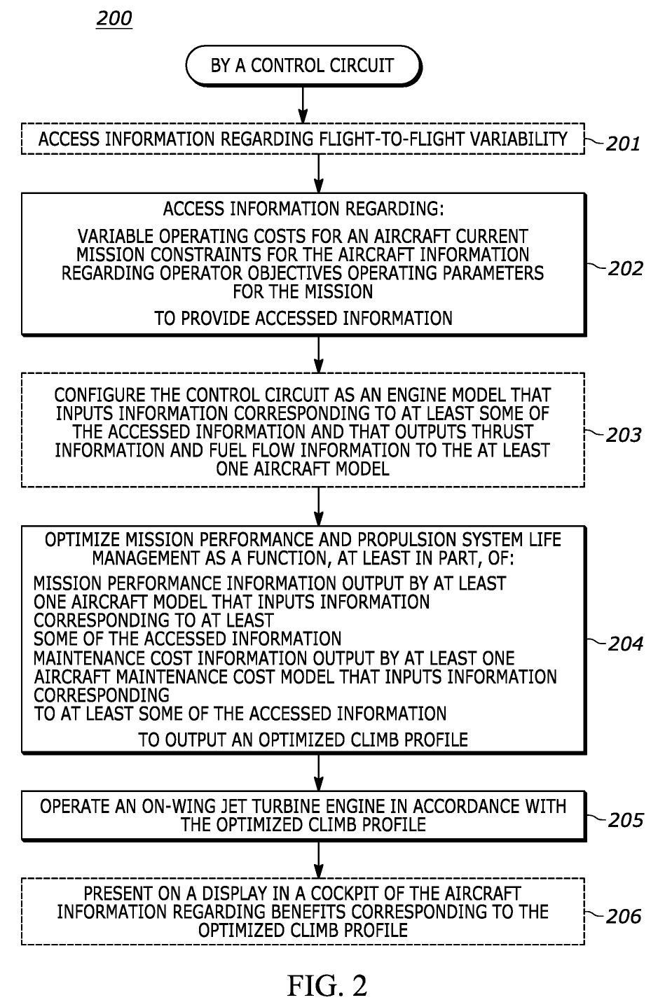

FIG. 2 presents a process 200 that can be carried out by the aforementioned control circuit 101. At optional block 201, the control circuit 101 accesses information regarding flight-to-flight variability to provide the accessed information that is discussed below in more detail. That information may be accessed in any of a variety of ways, including from original sources or from intermediate sources. Examples of items that exemplify flight-to-flight variability can include, but are not limited to, Mission/City Pairing (for example, one flight may be 1000 nautical miles in distance with approximately two hours of flight time while another flight may be 3000 nautical miles in distance with approximately five hours of flight time), Payload (for example, an aircraft may be operating at maximum takeoff weight (due to maximum passengers/cargo and fuel capacity) or it may be operating with a less-than-full compliment of passengers and/or fuel), Weather conditions (such as wind direction and magnitude), Vehicle and Propulsion System Health (reflecting, for example, that a more degraded system may burn more fuel than a less-degraded system and thus result in a lighter aircraft in-flight), Traffic Control (to account, for example, known navigational constraints such as forecasted air traffic along a planned mission), and Cost of Fuel (to account for variations in daily and/or location-based fuel prices).

At block 202, the control circuit 101 accesses information (for example, by accessing such information from the aforementioned memory 102) regarding one or more of the following items:

variable operating costs for the aircraft 100 (such as, but not limited to, cost information regarding crew, fuel, and maintenance for the aircraft 100);

current mission constraints for the aircraft 100 (such as, but not limited to, information regarding block time (which refers to the duration of time from the moment an airplane begins to move for the purposes of flight until it comes to rest at the end of a flight, including all taxi time on the ground at both the departure and arrival airports as well as the actual time spent in the air), information regarding time and distance to climb, and cruise insertion altitude (which refers to the altitude at which an aircraft levels off and enters the cruise phase of its flight) for the aircraft 100);

information regarding operator objectives that may be sourced, for example, by the aircraft manufacturer, an operator and/or owner of the aircraft, a crew member for the aircraft, or from some other appropriate source (as the operator objectives comprising, but not limited to, information regarding at least one of priorities regarding fuel versus time-based direct costs, priorities regarding near-term maintenance versus deferred maintenance, fleet maintenance planning, and minimization of unplanned engine removals); and/or

operating parameters for the mission;

At optional block 203, the control circuit 101 itself can be configured as an engine model that inputs information corresponding to at least some of the aforementioned accessed information and that outputs thrust information and fuel flow information to at least one aircraft model as described further below. These teachings will accommodate various approaches to so configuring the control circuit 101, with certain illustrative approaches described below in more detail.

At block 204, the control circuit 101 optimizes mission performance and propulsion system life management. By one approach, the control circuit 101 optimizes one or more selected mission performance parameters or metrics along with propulsion system life management as a function, at least in part, of mission performance information and maintenance cost information. There are numerous approaches to conduct such optimization. Generally speaking, optimization comprises selecting a best choice, with regard to some criteria, from some set of available alternatives. Optimizing often comprises maximizing or minimizing some function by systematically choosing input values from within an allowed set and computing the value of the function.

By one approach, the aforementioned mission performance information can be output by at least one aircraft model (such as the aforementioned aircraft model) that itself inputs information corresponding to at least some of the aforementioned accessed information. For many application settings, both engine thrust/power and fuel flow consumption would comprise useful inputs in these regards as engine thrust/power correlates to performance and fuel flow correlates to cost.

By one approach, the aforementioned cost information can be output by at least one aircraft maintenance cost model that itself inputs information corresponding to at least some of the accessed information. One salient example for maintenance cost information that can be output by the at least one aircraft maintenance cost model is maintenance monetary cost information.

At least one output of this optimization of mission performance and propulsion system life management step can be an optimized climb profile. Such a profile can detail such things as a cruise insertion altitude, climb airspeed, and at least one variable climb thrust/power demand. In addition to such operating parameters, the outputting of the optimized climb profile can also include information regarding at least one of estimated mission operating costs (including, as desired, direct and/or indirect operating costs), and estimated mission performance.

At block 205, the control circuit 101 operates the aforementioned on-wing jet turbine engine 105 in accordance with the optimized climb profile described above. Accordingly, and as one example, the corresponding cruise insertion altitude will be employed when operating the on-wing jet turbine engine 105.

By one optional approach, and as illustrated at block 206, these teachings will accommodate presenting (for example, on a display that comprises a part of the aforementioned user interface 103 in the cockpit 104 of the aircraft 100 (or that is located offboard the aircraft 100) and/or in a downloadable report) information regarding one or more benefits that correspond to the optimized climb profile. The particular benefits so communicated can vary with the needs of the user and/or the opportunities and needs of a given application setting. In some cases, this information regarding benefits can comprise a representative comparison of hardware life consumption relative to the consumption of life corresponding to nominal mission performance. As another example, this information regarding benefits can comprise a representative comparison of engine exhaust emissions (CO2, NOx, nvPM, and so forth) relative to an emissions level corresponding to nominal mission performance. An airline or other operator can utilize an exhaust emissions metric to substantiate, for example, climate impact. And as yet another example, this information regarding benefits can comprise a propulsion system "life consumed" metric (where, for example, a value of 100% can represent that it is time to remove a monitored system from revenue service). An airline or other operator can utilize the aforementioned life consumed metric as an input into their fleet management or planning to help ensure, for example, current and/or future availability of sufficient operating assets to apply to their routes.

Further details that comport with these teachings will now be presented. It will be understood that the specific details of these examples are intended to serve an illustrative purpose and are not intended to suggest any particular limitations with respect to these teachings.

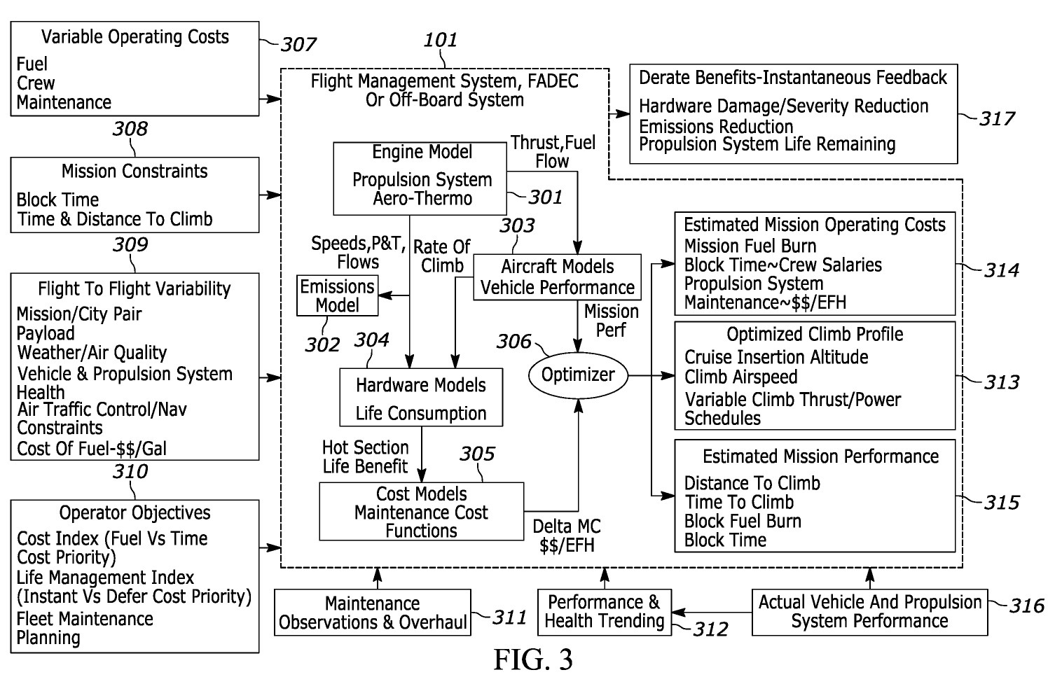

FIG. 3 presents an example where the control circuit 101 comprises an off-board system (i.e., off the aircraft itself) or a full authority digital engine control (FADEC), the latter being a system used in aviation to manage an aircraft's engine performance automatically and with precision. A FADEC is a computer-controlled system that regulates all aspects of engine performance, such as fuel flow, air intake, and ignition timing, without the need for manual intervention from the pilot. A FADEC typically continuously monitors a wide array of sensors within the engine, adjusting the control parameters to ensure optimal operation under varying conditions, such as changes in altitude, air temperature, and engine load.

In this example the control circuit 101 is configured as a plurality of different models, including an engine model 301 (which models the propulsion system’s aerodynamic and thermodynamic performance), an emissions model 302, one or more aircraft models 303 (which model the aircraft’s performance), one or more hardware models 304 (which model life consumption experience(s)), one or more cost models 305 (which model maintenance cost functions), and an optimizer 306.

The engine model 301 is configured to output information regarding propulsion system performance parameters such as speed, pressures, temperatures, and any of a variety of fluid flows to the emissions model 302. The engine model 301 is also configured to output information regarding thrust and fuel flow to the aircraft model(s) 303.

An engine model for a jet turbine engine is a mathematical representation or a simulation that is used to predict the behavior and performance of the engine and/or various components thereof under various operating conditions. Such models are often used to design, analyze, and optimize engines without the need for extensive physical testing.

An emissions model for a jet turbine engine is a computational tool designed to predict the types and quantities of pollutants that the engine emits during operation. These pollutants typically include nitrogen oxides (NOx), carbon monoxide (CO), unburned hydrocarbons (UHC), sulfur oxides (SOx), particulate matter (PM), and carbon dioxide (CO2). The purpose of the model is to estimate emissions for various phases of flight (takeoff, climb, cruise, descent, and landing) under different operating conditions. Such a model typically processes inputs using a combination of physical and chemical principles, empirical data, and mathematical algorithms to simulate the combustion process and subsequent emissions production. Inputs to such a model can include operational parameters (such as engine thrust settings, altitude, ambient temperature, pressure, and relative humidity), fuel properties (such as the type of fuel, its composition, and properties such as calorific value, carbon content, and sulfur content), engine characteristics (such as the bypass ratio, pressure ratio, turbine inlet temperature, and overall efficiency), and combustor design (including such things as the geometry of the combustion chamber, the fuel injection method, and the airflow pattern affect the combustion process and emissions). By one approach, the emissions model can output information such as a comparative difference in engine exhaust emissions (such as, for example, CO2, NOx, nvPM, and so forth) relative to an emissions level corresponding to nominal mission performance.

The aircraft model(s) 303 is configured to output information regarding rate of climb to the hardware model(s) 304 and is also configured to output information regarding mission performance to the optimizer 306. Aircraft models for a jet turbine aircraft are a mathematical representation or simulation that encapsulates the physical and aerodynamic properties of the aircraft. They are designed to predict the behavior of the aircraft under various conditions and control inputs. The model processes input to generate its output through a series of equations and algorithms that simulate the laws of physics as they apply to the aircraft.

The hardware model(s) 304 is configured to output information regarding hot section (of the engine) life benefits (generally predicated on the observation that hotter operating temperatures, which can be experienced while climbing to altitude, can contribute to a shorter engine life as compared to cooler operating temperatures) to the aforementioned cost model(s) 305. The cost model(s) 305, in turn, outputs information regarding maintenance costs (including cost differentials that reflect different climb behaviors) (and any other costs of interest), which cost information can be expressed using monetary values or engine flight hours.

The foregoing models can input any of a variety of information as appropriate. Examples include, but are not limited to, variable operating costs 307 (regarding costs for such things as fuel costs, crew costs, and maintenance costs), mission constraints 308 (regarding constraints for such things as block time as well as time and distance to climb), flight to flight variability 309 (regarding variables such as mission/city pairing, payload weight, weather and/or other factors pertaining to air quality, vehicle and propulsion system health, air traffic control instructions/regimens, navigational constraints, and the type and/or cost of fuel), and operator objectives 310 (regarding objectives for such things as a cost index (such as priorities between fuel consumption versus time (such as block time)), a life management index (such as priorities between incurring a cost later rather than later) and fleet management planning).

The control circuit 101 can also receive input regarding such things as maintenance observations and overhaul schedules 311 as well as performance and health trending information 312. Such feedback of maintenance observations and/or health trending information allows for informed adaptation of one or more of the various models on a unit-by-unit basis. Such information (such as maintenance observations, overhaul records, performance/health trending, and so forth) can be used, for example, to facilitate making real-time adjustments to the engine and/or hardware models on an engine-per-engine basis.

So configured, the optimizer 306 can output a variety of information, including the above-described optimized climb rate 313, estimated mission operating costs 314, and estimated mission performance 315. In the context of machine learning, mathematical programming, or optimization theory, optimizers typically employ an algorithm or a method to adjust the parameters of a model to minimize or maximize an objective function, which is often a measure of error or loss in machine learning, or a cost function in operations research. The optimizer serves to find the most efficient way to solve a given problem by iteratively improving upon a set of variables until the best possible solution (or a sufficiently good solution) is found within certain constraints.

To the extent the control circuit 101 has information regarding actual vehicle and propulsion system performance 316 (as when the control circuit 101 is a FADEC), that information can inform the performance and health trending information 312 noted above and can serve, for example, to further train one or more of the models described above.

If desired, and as denoted by reference numeral 316, the control circuit 101 can also output instantaneous (or near real-time) feedback (for example, via the aforementioned user interface 103) regarding the benefits of derating as is achieved via a particular output optimized climb profile (where derating refers to the intentional reduction in thrust output of an aircraft's engine below its maximum certified capability). This feedback can be qualitative and/or quantitative as desired, and can include content regarding such things as a corresponding reduction in the severity of damage (or wear), a reduction in emissions, and/or an indication of remaining life for the propulsion system that results by use of the optimized climb profile.

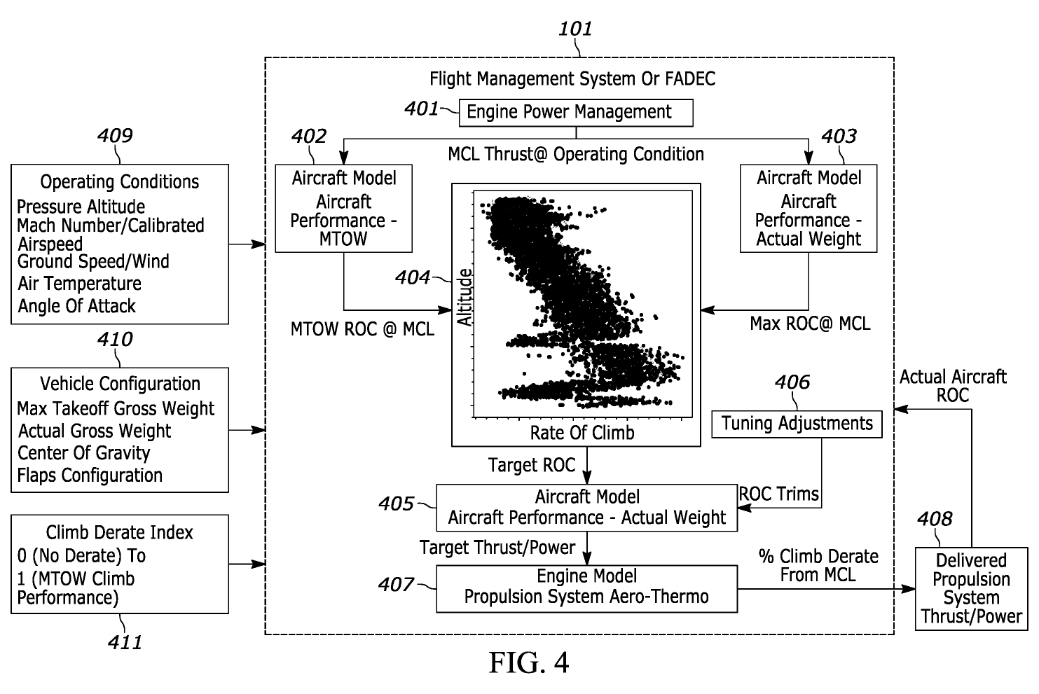

FIG. 4 presents another approach.

In this example, the control circuit 101 is configured as a FADEC or a flight management system. (A flight management system (FMS) is a computer system on an aircraft that automates in-flight tasks, such as navigation, flight planning, and fuel management. These systems typically use a predefined flight plan to calculate and display the aircraft's lateral and vertical trajectory, providing guidance throughout the flight.)

In this example, the control circuit 101 receives information regarding operating conditions 409, vehicle configuration 410, and the climb derate index 411 for the corresponding aircraft. The operating conditions 409 can comprise, for example, information regarding pressure and altitude, the aircraft’s mach number and calibrated airspeed, the aircraft’s ground speed and wind conditions, air temperature, the aircraft’s angle of attack, and so forth. The vehicle configuration 410 information can comprise, for example, the aircraft’s maximum takeoff gross weight, the aircraft’s actual gross weight, the aircraft’s center of gravity, the aircraft’s flaps configuration, and so forth. And the climb derate index 411 information can comprise, for example, a “0” to indicate “no derate” and a “1” to indicate maximum takeoff weight climb performance.

The control circuit 101 provides for engine power management 401 that outputs information regarding maximum climb thrust (MCL) and one or more operating conditions. (Maximum climb thrust is the maximum thrust that a pilot can demand from an engine during the climb phase of a flight.)

The information from the engine power management 401 is provided to two aircraft models 402 and 403. The first aircraft model 402 models aircraft performance with respect to the aircraft’s maximum takeoff weight (MTOW) (which is the maximum weight at which an aircraft is certified to take off) and which outputs the aircraft’s MTOW and rate of climb (ROC) (which refers to the vertical speed at which an aircraft is ascending; the rate of climb is a performance parameter that indicates how quickly an aircraft can gain altitude) with respect to maximum climb thrust. The second aircraft model 403 models the aircraft’s performance with respect to the aircraft’s actual weight and outputs information regarding maximum rate of climb with respect to maximum climb thrust.

The information from the foregoing two aircraft models 402 and 403 is input to an aircraft climb performance model 404.

The aircraft climb performance model 404 outputs information regarding a target rate of climb, which is input to a third aircraft model 405 that models aircraft performance with respect to its actual weight. In this illustrative example, this third aircraft model 405 also receives rate of climb trim information from a tuning adjustments 406 capability. The tuning adjustments can be based, for example, on a known aircraft deterioration state and/or the actual aircraft rate of climb.

This third aircraft model 405 outputs information regarding target thrust/power to an engine model 407 that models the aircraft’s propulsion system’s aerodynamic and thermodynamic aspects. (Such modeling typically serves to simulate and analyze both the airflow characteristics (aerodynamics) and the heat energy and temperature changes (thermodynamics) associated with a given propulsion system.) This engine model 407 outputs information regarding a percentage climb derate from the maximum climb thrust value which then serves to inform and control the thrust/power being delivered at any given moment by the aircraft’s propulsion system 408. If desired, information regarding the aircraft’s actual rate of climb can be fed back to the control circuit 101 for use by one or more of the foregoing models.

These teachings can provide for managing mission performance of an aircraft with respect to life management of the aircraft’s propulsion system. This management can include accessing variable operating cost information, current mission constraints for the aircraft, information regarding operator objectives, and operating parameters for an upcoming planned flight and then optimizing mission performance and propulsion system life management as a function, at least in part, of mission performance information output by at least one aircraft model that inputs information corresponding to at least some of the aforementioned information along with maintenance cost information output by at least one aircraft maintenance cost model that also inputs at least some of the aforementioned information. Pursuant to these teachings, that aircraft model can output an optimized climb profile that can then be employed to operate an on-wing jet turbine engine for the aforementioned aircraft. As a direct result, fuel consumption by the aircraft can be made efficient while also ensuring that other requirements for a given flight are met. Beyond that, the management of the propulsion system can be optimized in terms of a longer use horizon than just the current upcoming flight, thereby preserving, for example, undue wear and tear on that propulsion system.

Further aspects of the disclosure are provided by the subject matter of the following clauses:

Clause 1. A method to facilitate managing mission performance with respect to propulsion system life management for propulsion system on an aircraft, the method comprising: by a control circuit: accessing information regarding: - variable operating costs for the aircraft; - current mission constraints for the aircraft; - information regarding operator objectives; and - operating parameters for the mission; to provide accessed information; optimizing mission performance and propulsion system life management as a function, at least in part, of: - mission performance information output by at least one aircraft model that inputs information corresponding to at least some of the accessed information; and - maintenance cost information output by at least one aircraft maintenance cost model that inputs information corresponding to at least some of the accessed information; to output an optimized climb profile; and operating the propulsion system in accordance with the optimized climb profile.

Clause 2. The method of clause 1 wherein the information regarding the variable operating costs for the aircraft comprises cost information regarding crew, fuel, and maintenance for the aircraft.

Clause 3. The method of either of clause 1 or 2 wherein the information regarding the current mission constraints for the aircraft comprises information regarding block time, information regarding time and distance to climb, and cruise insertion altitude.

Clause 4. The method of any of clause 1 through 3 wherein the information regarding the operator objectives comprises information regarding at least one of priorities regarding fuel versus time-based direct costs, priorities regarding near-term maintenance versus deferred maintenance, fleet maintenance planning, and minimization of unplanned engine removals.

Clause 5. The method of any of clause 1 through 4 where the method further comprises: accessing information regarding flight-to-flight variability to provide the accessed information.

Clause 6. The method of any of clause 1 through 5 further comprising: configuring the control circuit as an engine model that inputs information corresponding to at least some of the accessed information and that outputs thrust information and fuel flow information to the at least one aircraft model.

Clause 7. The method of any of clause 1 through 6 wherein the maintenance cost information output by the at least one aircraft maintenance cost model comprises maintenance monetary cost information.

Clause 8. The method of any of clause 1 through 7 wherein the optimized climb profile comprises a cruise insertion altitude, climb airspeed, and at least one variable climb thrust/power demand.

Clause 9. The method of any of clause 1 through 8 wherein outputting the optimized climb profile further comprises outputting information regarding at least one of: estimated mission operating costs; and estimated mission performance.

Clause 10. The method of any of clause 1 through 9 further comprising: presenting on a display in a cockpit of the aircraft information regarding benefits corresponding to the optimized climb profile.

Clause 11. An apparatus to facilitate managing mission performance with respect to propulsion system life management for a propulsion system on an aircraft, the apparatus comprising: a control circuit configured to: access information regarding: - variable operating costs for the aircraft; - current mission constraints for the aircraft; - information regarding operator objectives; and - operating parameters for the mission; to provide accessed information; optimize mission performance and propulsion system life management as a function, at least in part, of: - mission performance information output by at least one aircraft model that inputs information corresponding to at least some of the accessed information; and - maintenance cost information output by at least one aircraft maintenance cost model that inputs information corresponding to at least some of the accessed information; to output an optimized climb profile; and operate the propulsion system in accordance with the optimized climb profile.

Clause 12. The apparatus of clause 11 wherein the information regarding the variable operating costs for the aircraft comprises cost information regarding crew, fuel, and maintenance for the aircraft.

Clause 13. The apparatus of either of clause 11 or 12 wherein the information regarding the current mission constraints for the aircraft comprises information regarding block time, information regarding time and distance to climb, and cruise insertion altitude.

Clause 14. The apparatus of any of clause 11 through 13 wherein the information regarding the operator objectives comprises information regarding at least one of priorities regarding fuel versus time, priorities regarding near-term maintenance versus deferred maintenance, fleet maintenance planning, and minimization of unplanned engine removals.

Clause 15. The apparatus of any of clause 11 through 14 wherein the control circuit is further configured to: access information regarding flight-to-flight variability to provide the accessed information.

Clause 16. The apparatus of any of clause 11 through 15 wherein the control circuit is further configured to: serve as an engine model that inputs information corresponding to at least some of the accessed information and that outputs thrust information and fuel flow information to the at least one aircraft model.

Clause 17. The apparatus of any of clause 11 through 16 wherein the maintenance cost information output by the at least one aircraft maintenance cost model comprises maintenance monetary cost information and engine flight hours information.

Clause 18. The apparatus of any of clause 11 through 17 wherein the optimized climb profile comprises a cruise insertion altitude, climb airspeed, and at least one variable climb thrust/power demand.

Clause 19. The apparatus of any of clause 11 through 18 wherein the control circuit is configured to output the optimized climb profile by outputting information regarding at least one of: estimated mission operating costs; and estimated mission performance.

Clause 20. The apparatus of any of clause 11 through 19 wherein the control circuit is further configured to: present on a display in a cockpit of the aircraft information regarding benefits corresponding to the optimized climb profile.

Clause 21. A system and method for determining optimal mission vehicle utilization by managing vehicle performance and propulsion system hardware life consumption based on an operator's cost objectives.

Clause 22. The system and method of clause 21 wherein the system and method allow the flight vehicle operator to prioritize direct operating costs (such as fuel, crew, maintenance) on a mission by mission basis.

Clause 23. The system and method of either of clauses 21 and 22 wherein the system and method performs an optimization of mission performance and propulsion system life management based on the integration of propulsion system hardware life consumption modeling and operating cost functions into flight management planning and propulsion system power management.

Clause 24. The system and method of any of clauses 21-23 further comprising a life management index input that provides operators with enhanced flight-to-flight cost prioritization between deferred maintenance costs and instantaneous mission time-based costs, such that time-based cost prioritization can be accomplished via climb profile optimization.

Clause 25. The system and method of any of clauses 21-24 further comprising climb profile optimization that includes integration of hot section hardware life consumption models (such as a cumulative damage model (CDM) and/or a life fraction utilization model (LFU)) that are integrated into tuned propulsion system models and tuned propulsion system maintenance cost models, where in the models can be tuned based on maintenance observations, overall propulsion system health trending, and overhaul records.

What is claimed is:

1. A method to facilitate managing mission performance of a mission with respect to propulsion system life management for an on-wing propulsion system on an aircraft, the method comprising:
by a control circuit:
accessing information regarding:
variable operating costs for the aircraft;
current mission constraints for the aircraft;
information regarding operator objectives; and
operating parameters for the mission;
to provide accessed information;
optimizing mission performance and propulsion system life management as a function, at least in part, of:
mission performance information output by at least one aircraft model that inputs information corresponding to at least some of the accessed information; and
maintenance cost information output by at least one aircraft maintenance cost model that inputs information corresponding to at least some of the accessed information;
to output an optimized climb profile; and
operating the on-wing propulsion system in accordance with the optimized climb profile by, at least in part, employing a cruise insertion altitude that comprises a part of the optimized climb profile when operating the on-wing jet turbine engine.

2. The method of claim 1 wherein the information regarding the variable operating costs for the aircraft comprises cost information regarding crew, fuel, and maintenance for the aircraft.

3. The method of claim 1 wherein the information regarding the current mission constraints for the aircraft comprises information regarding block time, information regarding time and distance to climb, and cruise insertion altitude.

4. The method of claim 1 wherein the information regarding the operator objectives comprises information regarding at least one of priorities regarding fuel versus time-based direct costs, priorities regarding near-term maintenance versus deferred maintenance, fleet maintenance planning, and minimization of unplanned engine removals.

5. The method of claim 1 where the method further comprises:
accessing information regarding flight-to-flight variability to provide the accessed information.

6. The method of claim 1 further comprising:
configuring the control circuit as an engine model that inputs information corresponding to at least some of the accessed information and that outputs thrust information and fuel flow information to the at least one aircraft model.

7. The method of claim 1 wherein the maintenance cost information output by the at least one aircraft maintenance cost model comprises maintenance monetary cost information.

8. The method of claim 1 wherein the optimized climb profile comprises a cruise insertion altitude, climb airspeed, and at least one variable climb thrust/power demand.

9. The method of claim 1 wherein outputting the optimized climb profile further comprises outputting information regarding at least one of:
estimated mission operating costs; and
estimated mission performance.

10. The method of claim 1 further comprising:
presenting on at least one of a display in a cockpit of the aircraft and a post-flight report information regarding benefits corresponding to the optimized climb profile.

11. An apparatus to facilitate managing mission performance of a mission with respect to propulsion system life management for a propulsion system on an aircraft, the apparatus comprising:
a control circuit configured to:
access information regarding:
variable operating costs for the aircraft;
current mission constraints for the aircraft;
information regarding operator objectives; and
operating parameters for the mission;
to provide accessed information;
optimize mission performance and propulsion system life management as a function, at least in part, of:
mission performance information output by at least one aircraft model that inputs information corresponding to at least some of the accessed information; and
maintenance cost information output by at least one aircraft maintenance cost model that inputs information corresponding to at least some of the accessed information;
to output an optimized climb profile; and
operate the propulsion system in accordance with the optimized climb profile by, at least in part, employing a cruise insertion altitude that comprises a part of the optimized climb profile when operating the on-wing jet turbine engine.

12. The apparatus of claim 11 wherein the information regarding the variable operating costs for the aircraft comprises cost information regarding crew, fuel, and maintenance for the aircraft.

13. The apparatus of claim 11 wherein the information regarding the current mission constraints for the aircraft comprises information regarding block time, information regarding time and distance to climb, and cruise insertion altitude.

14. The apparatus of claim 11 wherein the information regarding the operator objectives comprises information regarding at least one of priorities regarding fuel versus time, priorities regarding near-term maintenance versus deferred maintenance, fleet maintenance planning, and minimization of unplanned engine removals.

15. The apparatus of claim 11 wherein the control circuit is further configured to:
access information regarding flight-to-flight variability to provide the accessed information.

16. The apparatus of claim 11 wherein the control circuit is further configured to:
serve as an engine model that inputs information corresponding to at least some of the accessed information and that outputs thrust information and fuel flow information to the at least one aircraft model.

17. The apparatus of claim 11 wherein the maintenance cost information output by the at least one aircraft maintenance cost model comprises maintenance monetary cost information and engine flight hours information.

18. The apparatus of claim 11 wherein the optimized climb profile comprises a cruise insertion altitude, climb airspeed, and at least one variable climb thrust/power demand.

19. The apparatus of claim 11 wherein the control circuit is configured to output the optimized climb profile by outputting information regarding at least one of:
estimated mission operating costs; and
estimated mission performance.

20. The apparatus of claim 11 wherein the control circuit is further configured to:
present on at least one of a display in a cockpit of the aircraft and a post-flight report information regarding benefits corresponding to the optimized climb profile.
